(19) United States
(12) Patent Application Publication
(10) Pub. No.: US 2009/0008040 A1
(43) Pub. Date: Jan. 8, 2009

(54) Hive-Shaped Blind

(76) Inventor: Shih-Ming Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/773,648

(22) Filed: Jul. 5, 2007

(51) Int. Cl. E06B 9/38; E06B 9/26

(52) U.S. Cl. 160/236; 160/166.1

(57) ABSTRACT

A hive-shaped blind has multiple slats each composed of an inner blind sheet and an outer blind sheet individually with a binding section. Therefore, the inner blind sheet and the outer blind sheet are combined together at the binding sections to compose the slat. Lastly, multiple slats are stringed in parallel to achieve the hive-shaped blind.

### BACKGROUND OF THE INVENTION

1. Field of the Invention

The present invention relates to a hive-shaped blind, and more particularly to a hive-shaped blind that is composed of two asymmetrical blind sheets each with a binding section.

2. Description of Related Art

With reference to a conventional hive-shaped blind as shown in FIG. 1, each slat is made of a single blind sheet longitudinally folded into four even parts. Typically, the single blind sheet is dyed with two different colors in half and tubed by attaching two ends of the single blind sheet to achieve the slat. Multiple slats are stringed to compose the hive-shaped blind with a excellent ventilative efficiency and an expanded appearance.

However, in the conventional hive-shaped blind, the slats usually have color disperse (that causes off colors) at joints because two halves on the same slat are dyed with two different colors. The dying operation of the slat needs a high-precision machine to achieve the dual-color slat but still has high defect rate in manufacturing so that the selling price of the hive-shaped blind is correspondingly increased.

### SUMMARY OF THE INVENTION

A main objective of the present invention is to provide a hive-shaped blind that can be manufactured and assembled rapidly and has nice quality in appearance.

To achieve the foregoing objective, the hive-shaped blind has multiple slats each comprising:

a first blind sheet with at least one binding section; and

a second blind sheet with at least one binding section;

wherein, the first blind sheet and the second blind sheet are combined with each other by the at least one binding section on the first blind sheet and the second blind sheet to perform each slat.

By composing the slats with multiple blind sheets with the binding sections, the slat can be produced easily, combined rapidly with strong structure, and have more variety in appearance.

Further benefits and advantages of the present invention will become apparent after a careful reading of the detailed description with appropriate reference to the accompanying drawings.

### BRIEF DESCRIPTION OF THE DRAWINGS

FIG. 1 is a partially extended perspective view of a conventional hive-shaped blind in accordance with the prior art;

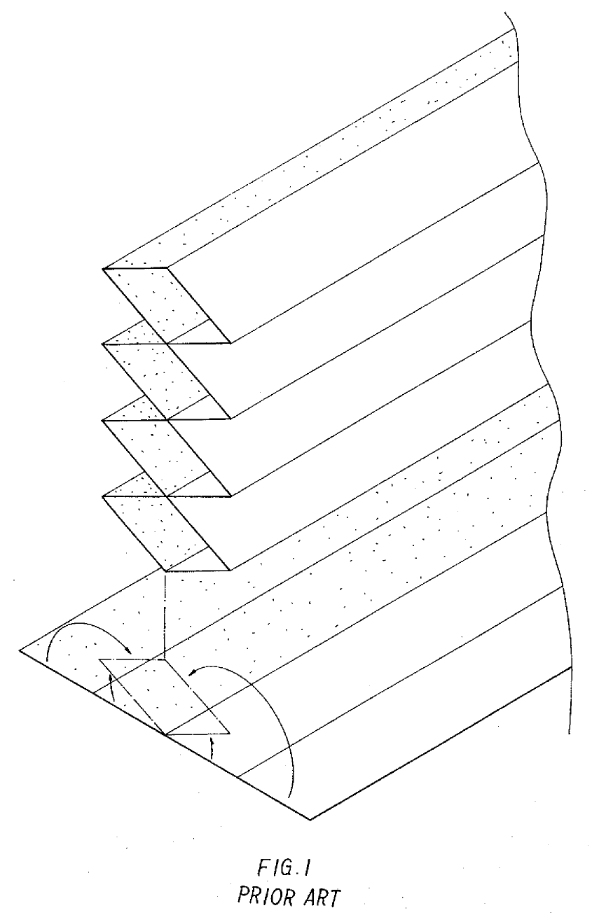

FIG. 2 is a partially exploded perspective view of a hive-shaped blind in accordance with the present invention;

FIG. 3 is an assembled perspective view of the hive-shaped blind in FIG. 2;

FIG. 4 is an operational perspective view of one embodiment of the hive-shaped blind attached to a controlling assembly;

FIG. 5 is an operational perspective view of another embodiment of the hive-shaped blind attached to the controlling assembly; and

FIG. 6 is partially exploded perspective view of a hive-shaped blind in accordance with the present invention, wherein each slat is hexagon in cross-section.

### DETAILED DESCRIPTION OF THE PREFERRED EMBODIMENT

A hive-shaped blind in accordance with the present invention has multiple slats each composed of an inner blind sheet and an outer blind sheet individually with a binding section. Therefore, the inner blind sheet and the outer blind sheet are combined together at the binding section to compose the slat. Lastly, multiple slats are stringed to achieve the hive-shaped blind.

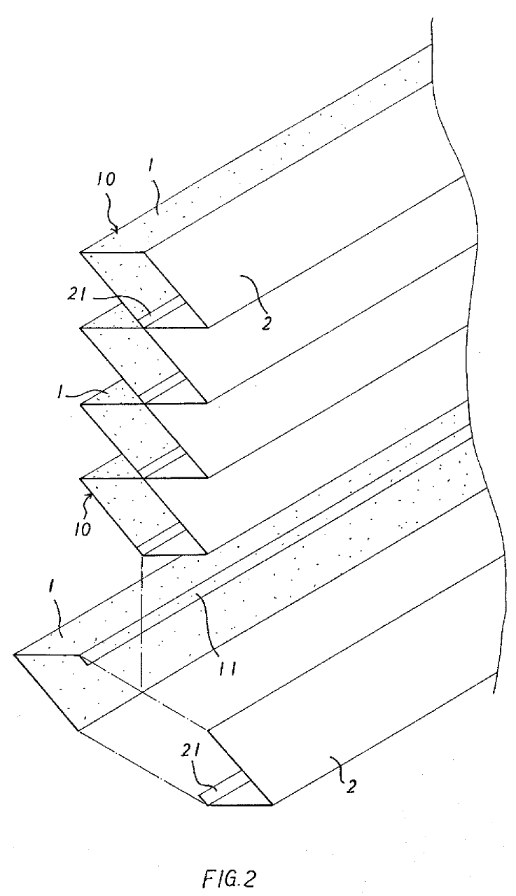

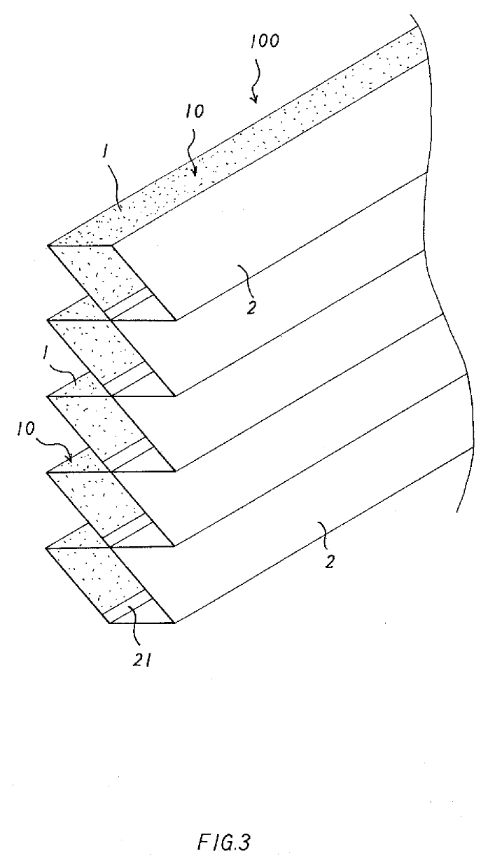

A preferred embodiment of the hive-shaped blind has multiple slats each comprising an inner blind sheet 1 and an outer blind sheet 2 (as shown in FIG. 2) with pre-impressed grooves. Each of blind sheets 1, 2 has two longitudinal ends and a binding section 11, 21 extending from one of the two longitudinal ends. The binding section 11, 21 overlaps with the other of the two longitudinal ends to make the inner and outer blind sheet 1, 2 to combine with each other (i.e. by gluing or binding) after the inner and outer blind sheets 1, 2 are respectively dyed to perform a tubular slat 10. Then, multiple tubular slats 11 are stringed in parallel to achieve the hive-shaped blind 100 (as shown in FIG. 3).

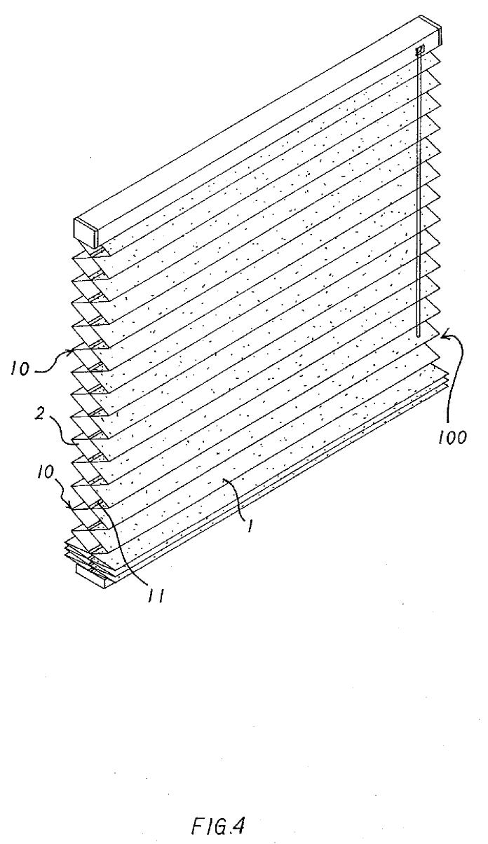

According to the structure in the foregoing description, the slat is composed of one inner blind sheet 1 and one outer blind sheet 2 so that both blind sheets 1, 2 can be dyed individually in different dyeing processes that need no high technique to carry out and has no worry about color dispersion on the same blind sheet (no off color) to ensure the dyeing performance best (as shown in FIG. 4). Additionally, the binding sections 11, 21 on the inner blind sheet 1 and the outer blind sheet 2 at opposite ends provide more adhesion area to make the combined slat 10 to have excellent strength, easy assembly and low defect rate. Therefore, manufacturers can provide a produced hive-shaped blind with fine quality and low selling price to consumers. Both manufacturers and consumers get benefits to have win-win situation.

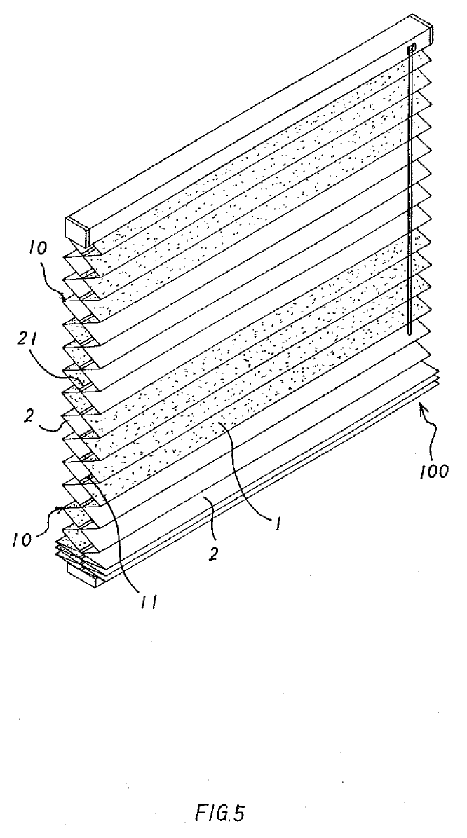

Moreover, another embodiment of the hive-shaped blind is performed by turning the inner blind sheets 1 into the outer blind sheets 2 at selected slats 10 to make the appearance of the hive-shaped blind various (as shown in FIG. 5) to have more variety for different consumers with different requirements. In more preferred embodiments, the slat can be performed by multiple blind sheets in the same manner.

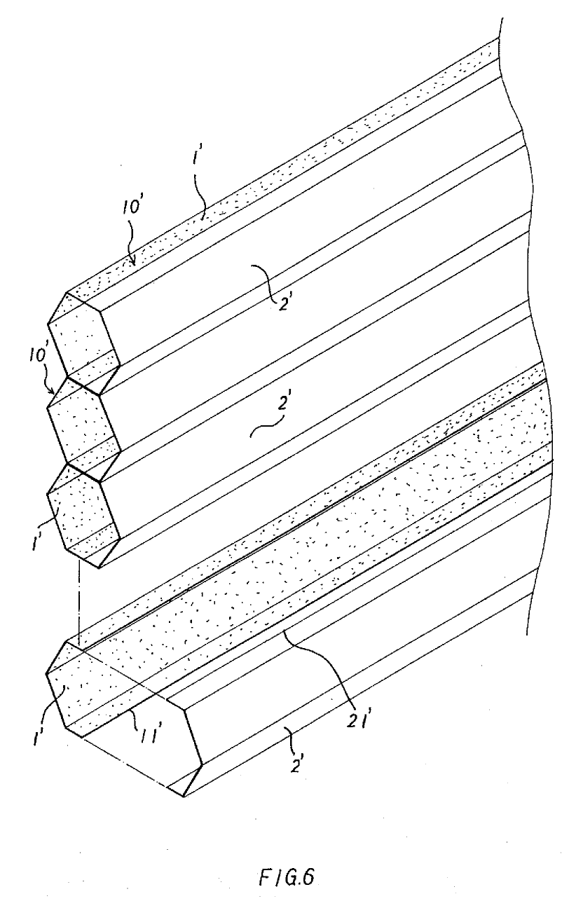

Furthermore, the slat 10′ is modified into different tubular body with a polygonal cross-section. The inner blind sheet 1′ and the outer blind sheet 2′ each have two binding sections 11′, 12′ at edges of two longitudinal ends for combination and are respectively impressed to have two middle sections between the two binding sections 11′, 12′. The performed tubular slat 10′ has a hexagonal cross-section and is stringed with other similar ones in parallel to achieve the hive-shaped blind 100′ (as shown in FIG. 6).

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A hive-shaped blind comprising multiple slats stringed together, each of the multiple slats comprising:
a first blind sheet with at least one binding section; and
a second blind sheet with at least one binding section;
wherein, the first blind sheet and the second blind sheet are combined with each other by the at least one binding section on the first blind sheet and the second blind sheet to perform each slat.

2. The hive-shaped blind as claimed in claim 1, wherein the first blind sheet has two longitudinal ends and two binding sections respectively at edges of the two longitudinal ends;
the second blind sheet has two longitudinal ends and two binding sections respectively at edges of the two longitudinal ends thereon.
